(19) United States
(12) Patent Application Publication
(10) Pub. No.: US 2010/0042647 A1
(43) Pub. Date: Feb. 18, 2010

(54) METHOD AND SYSTEM FOR RECORDING REAL-TIME COMMUNICATIONS

(75) Inventors: Paul T. Schultz, Colorado Springs, CO (US); Robert A. Sartini, Colorado Springs, CO (US); Martin W. McKee, Herndon, VA (US)

Correspondence Address: VERIZON;PATENT MANAGEMENT GROUP, 1320 North Court House Road, 9th Floor, ARLINGTON, VA, 22201-2909, US

(73) Assignee: Verizon Business Network Services Inc., Ashburn, VA (US)

(21) Appl. No.: 12/191,651

(22) Filed: Aug. 14, 2008

(51) Int. Cl. G06F 17/00

(52) U.S. Cl. 707/104.1

(57) ABSTRACT

An approach is provided for buffering and recording real-time communications and then delivering the recorded communication to a user-specified device in a user-specified format.

### BACKGROUND INFORMATION

Consumers, businesses, and governments alike are more dependent than ever on modern telecommunication systems to exchange vast amounts of information in a growing variety of formats (e.g., voice, video conferencing, text messaging, multimedia messaging, instant messaging, and electronic mail). This information ranges from normal day-to-day conversations to time-critical business or public safety information. In many cases, users find the need to record and store these communications because of the importance or value of the information.

For certain types of communications (e.g., text messaging, multimedia messaging, instant messaging, and electronic mail), the process of recording and storing the communication is relatively easy. These types of communications are transmitted in a form that is already stored in the memory of the device used to transmit and/or receive the communication. The user need only designate which items the user wants to store. Additionally, with the exception of instant messaging, these types of communications are not conducted in real-time which gives the user ample time and opportunity to decide whether to store the communication session.

However, for communications that involve real-time exchanges between one or more parties (e.g., voice calls, video calls, and video conferencing), the process for recording and storing the communication is not straightforward, and, at times, not possible. Conventional telecommunication systems do not provide a universal means to record these types of real-time communications.

Therefore, there is a need for an approach that provides for automated and seamless buffering, recording, and delivery of real-time communications using existing communication devices.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of buffering, recording, and delivering real-time communications, according to an exemplary embodiment;

FIG. 2 is a diagram of the components of the content buffering, recording, and delivery platform, according to an exemplary embodiment;

FIG. 3 is a flowchart of a process for specifying user profile and rules for the content buffering, recording, and delivery service, according to an exemplary embodiment;

FIG. 4 is a flowchart of a process for buffering, recording, and delivering real-time communications, according to an exemplary embodiment;

FIG. 5 is a flowchart of a process for recording and delivering an entire communication session, according to an exemplary embodiment;

FIG. 6 is a flowchart of a process for recording and delivering a partial communication session, according to an exemplary embodiment;

FIG. 7 is a flowchart of a process for recording and delivering a communication session in real-time, according to an exemplary embodiment;

FIG. 8 is a flowchart of a process for using a content buffering, recording, and delivery service, according to an exemplary embodiment;

FIG. 9 is a diagram of exemplary controls and user interface of a mobile device utilized in the processes of FIGS. 2-8, according to an exemplary embodiment;

FIG. 10 is a diagram of exemplary controls and user interface of a laptop device utilized in the processes of FIGS. 2-8, according to an exemplary embodiment; and

FIG. 11 is a diagram of a computer system that can be used to implement various exemplary embodiments.

### DESCRIPTION OF THE PREFERRED EMBODIMENT

A preferred apparatus, method, and system for buffering, recording, and delivering real-time communications are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a mobile device, it is contemplated that these embodiments have applicability to any device capable of communicating over a network, such as a home communication terminal (HCT), a digital home communication terminal (DHCT), television system Set Top Box (STB), landline connected to a Public Switched Telephone Network (PSTN), a personal digital assistant (PDA), laptop computer, and/or a personal computer (PC), as well as other like technologies and customer premises equipment (CPE).

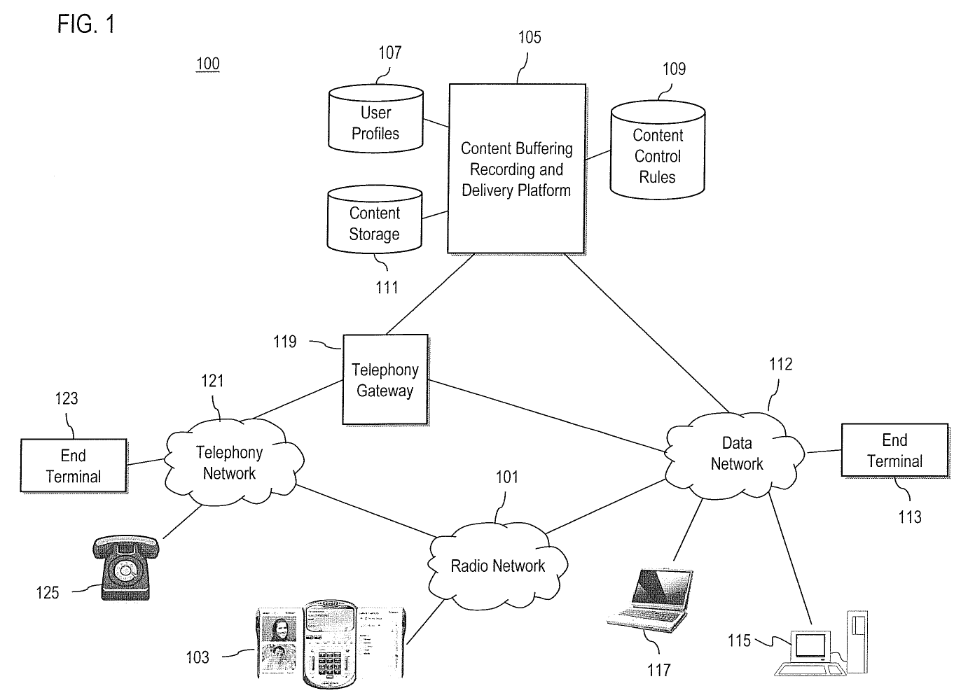

FIG. 1 is a diagram of a system capable of buffering, recording, and delivering real-time communications, according to an exemplary embodiment. For the purposes of illustration, a mechanism for buffering, recording, and delivering real-time communications is described with respect to a communication system 100 that includes a radio network 101 that provides access by a mobile device 103 to a content buffering, recording, and delivery platform (hereinafter “content recording platform”) 105. The content recording platform 105 enables buffering, recording, and delivery of real-time communications to users utilizing existing communication devices. Specifically, the platform 105 automatically buffers real-time communication sessions, including all associated media and relevant signaling (e.g., calling/called party identifiers, out-of-band transmission of key presses by the user), to enable the user to obtain a recording of the communication session even after the communication has occurred. The platform 105 delivers the recorded communication session to a user-specified device in a user-specified format. In this embodiment, the content recording platform 105 resides on the network side of the system 100 to enable a service provider to easily manage the platform 105 and its associated service.

In this embodiment, the radio network 101 is a cellular network and may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like.

As discussed above, conventional telecommunication systems lack the built-in capability to automatically buffer, record, and deliver real-time communication sessions. Generally, a user must use additional recording equipment (e.g., tape recorders or video recorders) to facilitate capture of the information. Often times, the user will find that this additional equipment is not present or available when the user wants to record a communication. Furthermore, because the communication is occurring in real-time, the user may not realize that he or she wants to record the information until the communication has already been received. At that point, the information is already lost. Thus, without preconfigured or installed recording equipment, users risk losing valuable information exchanged during real-time communications. Furthermore, communications service providers are continually challenged to develop new services and features to remain competitive and to develop new sources of revenue.

To address the above problem, the content recording platform 105 uses a content buffering, recording, and delivery control component to interact with a real-time communications network (e.g., system 100) and provide content recording services to network users. The user can configure the service to, for example, “always buffer 30 minutes of voice and multimedia (e.g., voice and video) communication sessions” and configure a key sequence (“*R”) on the communication device to initiate recording and delivery of the content. This configuration might, for example, result in receiving an E-mail with an attached audio file of a voice conversation.

The following examples illustrate the different capabilities of the content recording platform 105.

In a first example, a school administrator answers a phone call in which the caller makes a bomb threat to the school. Unknown to the caller, the administrator enters a key sequence on her telephone to initiate recording and immediate delivery of the phone call as she continues talking. The content recording platform 105 immediately delivers an E-mail containing an audio file of a recording of the phone call up to the point of the recording and delivery request. The administrator immediately forwards the E-mail to her emergency contact list. As the call continues, the administrator enters the recording and delivery key sequence several times during the conversation. Each time, the content recording platform 105 delivers a recording of the entire conversation up to initiation of the record and deliver request. At the end of the phone call, the content recording platform 105 delivers an E-mail with an audio file of the entire conversation. The administrator also may configure the option to create a speech-to-text transcript of the recording that the content recording platform 105 can deliver by E-mail or other text-based messaging options (e.g., short messaging service (SMS) or multimedia messaging service (MMS)).

In another example, a business user watching and listening to a routine video conference call realizes important business changes were just announced. She decides that she did not capture all the details of the announcement and enters her recording key sequence on her personal computer. At the end of the video conference, the content recording platform 105 posts a recording of the multimedia communication session to an Internet site where she can later view, retrieve, copy, edit and forward the relevant portions of the video conference call to her team.

In a final example, a young woman is driving late at night on a rural highway and is pulled over by a vehicle with a flashing light. The young woman is unsure of the identity of the man in the car and initiates a video call to her father as a man approaches. The father enters his key sequence on his phone to record and immediately deliver the video call. The father then asks his daughter to remain in the car with the doors locked until the father can verify the approaching man's identity. As preconfigured by the father, the content recording platform 105 immediately delivers an E-mail containing a video capture of the man approaching the car. The father forwards the email to the local police to check the man's identity. Once the local police verifies the man's identity as a police officer, the father relays the information to the daughter.

As seen in FIG. 1, the content recording platform 105 has access to a database 107 of user profiles, a database 109 of content control rules, and a database 111 of content storage. The user profile database 107 stores information such as the user's identification and service provisioning status. The content control rules database 109 stores the rules and configurations that each user creates to direct how the content recording platform 105 will buffer, record and deliver communication sessions of various formats. The database 109 also stores key sequences created by the user to invoke previously created rules and select recording and delivery options. The content storage database 111 stores buffered content and recordings created by the user.

The content recording platform 105 is connected to a mobile device 103 via radio network 101. The content recording platform 105 also has connectivity to a data network 112 that supports an end terminal 113. The end terminal 113 can be any computing device that provides access to the content recording platform 105. Under certain embodiments, end terminal 113 can include laptop computer 117 among other like computing devices. It is contemplated that a user can access content recording platform 105 functions and settings for the mobile device 103 through either the end terminal 113 or laptop 117. The data network 112 maybe any local area network (LAN), metropolitan area network (MAN), wide area network (WAN), the Internet, or any other suitable packet-switched network, such as a commercially owned, proprietary packet-switched network, e.g., a proprietary cable or fiber-optic network.

The data network 112 additionally permits a host 115 to access content recording platform 105 functions and settings via a graphical user interface (GUI) such as a browser application or any web-based application for the mobile device 103. As a result, the user of the mobile device 103 can input and update controls, rules, and configurations for the content recording platform 105 through a web browser, through end terminal 113, through laptop 117, or through the mobile device 103 itself. Alternatively, the host 115 can run applications to access content recording platform 105 functions and settings.

The content recording platform 105 is linked to the data network 112 and a telephony gateway 119 for connectivity to the telephony network 121. In this example, the telephony network 121 can provide access from the end terminal 123 or telephony device 125 to the content recording platform 105. In this way, users of telephonic devices (e.g., end terminal 123 and telephony device 125) on plain old telephone service (POTS) can use these devices to access the content buffering, recording, and delivery services provided by platform 105. The telephony network 121 may be a Public Switched Telephone Network (PSTN), a Public Land Mobile Network (PLMN), or similar.

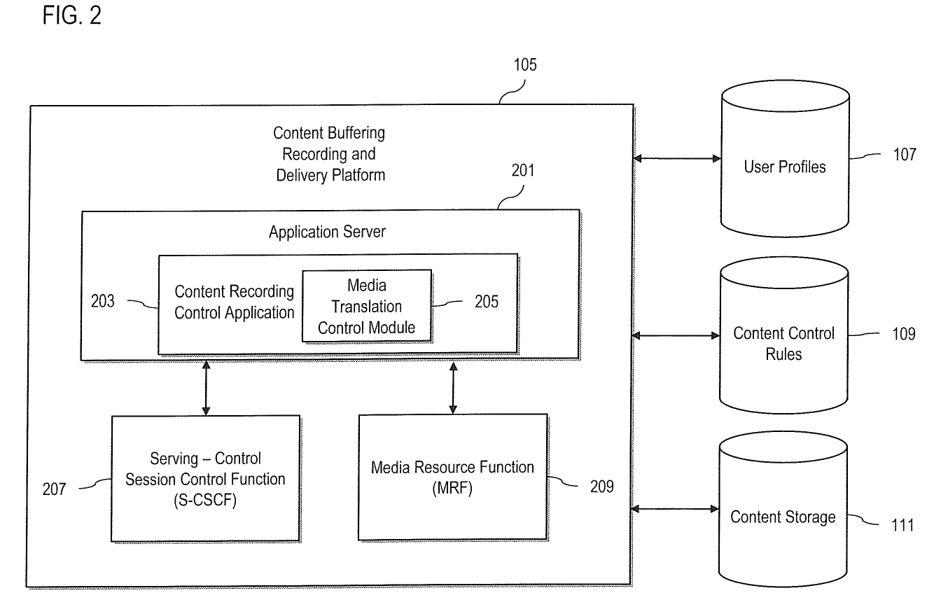

FIG. 2 is a diagram of the components of the content buffering, recording, and delivery platform, according to an exemplary embodiment. In this embodiment, the content recording platform 105 includes an application server 201 running the content recording control application 203. In addition, the content recording platform 105 leverages the IP Multimedia Subsystem (IMS) architecture by including an IMS Serving-Call Session Control Function (S-CSCF) 207 and an IMS Media Resource Function (MRF) 209. The S-CSCF 207 controls and directs voice and multimedia sessions to the content control application 203 for processing. The MRF 209, in turn, manages and distributes media resources (e.g., recordings and buffered content stored in the content storage database 111) among the content control application 203, other components of the content recording platform 105 (e.g., content storage database 111), and user devices (e.g., mobile device 103, laptop 117, telephony device 125).

The content recording control application 203 interacts with the user profile database 107 and the content control rules database 109 to determine the content buffering, recording, and delivery rules applicable to each user and communication session. The application 203 then commands the MRF 209 to buffer and/or record communication sessions according to the user's request and store the recording in the content storage database 111. To assist in the delivery of a recorded communication session, the application 203 incorporates a media translation control module 205 that commands the MRF 209 to convert the recorded session to a format requested by the user (e.g., voice mail, E-mail, SMS, MMS, etc.). The MRF 209 can include additional subsystems (e.g., speech recognition engine) to help convert one media format to another (e.g., creation of a speech-to-text transcript of a voice communication session).

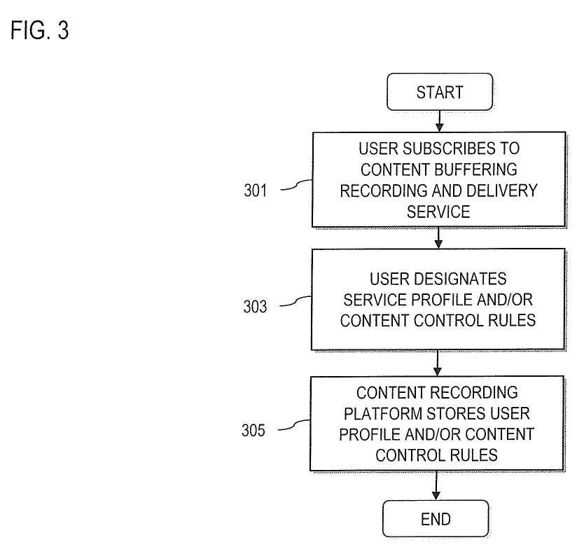

The operation of the content recording platform 105 is now described in FIGS. 3 through 8.

FIG. 3 is a flowchart of a process for specifying user profile and rules for the content buffering, recording, and delivery service, according to an exemplary embodiment. In step 301, a user subscribes to the content buffering, recording, and delivery service; on subscription to the service, the content recording platform 105 will begin buffering, recording, and delivering real-time communication sessions to the user. During the setup process, the content recording platform 105 can prompt the user to create a user profile that contains, for example, information such as the user's identification and network devices, as well as content control rules and configurations. Such parameters are specified by the user, per step 303, as part of a service provisioning process in this embodiment.

The content control rules and configuration directs how the content recording platform 105 will buffer, record, and deliver real-time communications. These rules can be quite extensive and include specifications on what communication sessions to buffer (e.g., buffer all real-time communications, buffer voice communications only, buffer video communications only), how long to buffer (e.g., 5 minutes, 15 minutes, 30 minutes, etc.), format of the recording (e.g., audio recording, video recording, speech-to-text transcript), delivery mechanism (e.g., voice mail, E-mail, SMS, MMS, Internet link), and delivery device (e.g., user's device, a third party's device). It is contemplated that the user can use the same rules and configuration for all real-time communications or can create separate sets of rules for each type of communication. For example, the user may have one set of rules for voice communications, another set of rules for video communications, and a third set for multimedia conferencing. Additionally, the user can configure rules based on their different public user identities (e.g., work, student, and home identities). Alternatively, these rules can be pre-defined by the service provider and serve as defaults.

As part of the setup process, the content recording platform I 105 can further prompt the user to create unique key sequences to invoke specific recording rules. For example, the user can designate that the key sequence “*R” to initiate recording of the communication session or the key sequence “*D” to immediately deliver a recording of the communication up to the point of the request. It is contemplated that the user can create any number of key sequences to dynamically control platform parameters including delivery format or device.

In step 305, the content recording platform 105 completes the subscription setup process by storing the user profile in the user profile database 107 and, optionally, the rules and configuration in the content control rules database 109. In one embodiment, the user can modify the stored configuration at any time, using any appropriate mechanism and device (e.g., mobile device 103). Further, it is contemplated that such rules can be specified by another user or entity (e.g., service provider, system administrator, etc.).

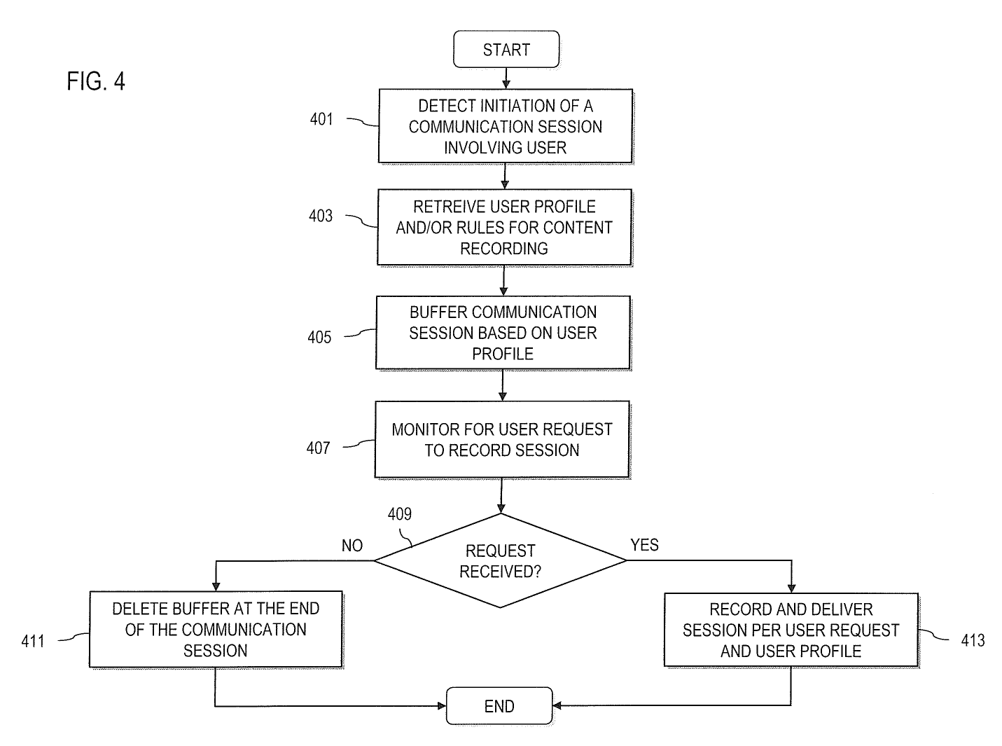

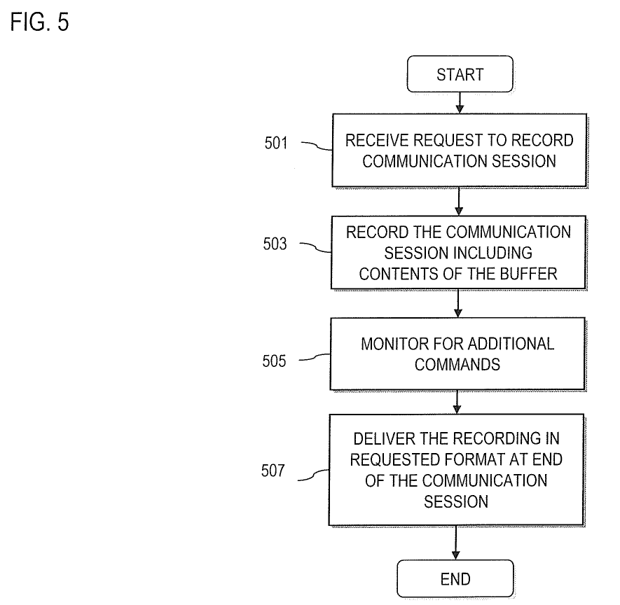

FIG. 4 is a flowchart of a process for buffering, recording, and delivering real-time communications, according to an exemplary embodiment. In step 401, the content recording platform 105 detects that a real-time communication session is established by a service subscriber. This detection can be signaled to the content recording platform 105 by the user's device or an intermediate node (e.g., telephone switch, cellular gateway, S-CSCF, telephony gateway 119, etc.). Next, the content recording platform 105 identifies the user to the communication session as a valid subscriber. It is assumed that any type of authentication process can be employed to ensure the user is an authorized subscriber to the content buffering, recording, and delivery service. In step 403, the content recording platform 105 retrieves the user profile, content control rules, and configuration. The content recording platform 105 begins buffering the user's communication session based on the user's configuration (step 405). Concurrently, the content recording platform 105 monitors for a request by the user to record the ongoing communication session (steps 407 and 409). If the content recording platform 105 receives no request to record the communication session by the end of the session, the platform 105, by default in this example, will delete the buffered content when the session ends per step 411. In certain embodiments, the user can specify the amount of time the content recording platform 105 will store buffered content before deleting the buffer. If the content recording platform 105 receives a record request from the user, the platform 105 will record and deliver the communication session based on the user's request and configuration per step 413. The process for recording and delivering real-time communication sessions is described in more detail with respect to FIGS. 5-7.

The content recording platform 105 enables the user to have great flexibility in determining how the platform 105 will record and deliver real-time communication sessions. Three exemplary recording options are described below.

FIG. 5 is a flowchart of a process for recording and delivering an entire communication session, according to an exemplary embodiment. Under this recording option, the content recording platform 105 receives a request from the user to record an ongoing communication session and to deliver a single complete recording at the end of the communication session (step 501). This option can be useful for recording a communication session for later reference as illustrated in the example (discussed above) of the business user recording a video conference call for later reference.

On receipt of this request, the content recording platform 105 begins recording the communication session including the portion of the session that has already been captured in the platform's buffer (step 503). In this way, the user can initiate a recording request any time before the content buffer reaches its preconfigured capacity and still receive a complete recording of the communication session. If the buffer reaches its recording capacity before the user initiates a recording request, the content recording platform will deliver the content available in the buffer along with the rest of the communication from the point of the recording request.

The content recording platform 105 continues to monitor for and execute additional user requests until the end of the communication session (step 505). At the end of the communication session in step 507, the content recording platform 105 converts the recording into the user's requested format and deliver the recording to the specified device or devices according to the user's preferences and rules contained in the user profile database 107 and content control rules database 109. In this embodiment, available formats for recordings of real-time communication sessions include audio recordings, video recordings, and speech-to-text transcripts. The recording format dictates the delivery mechanisms available to the user. For example, if the user selects delivery of the communication session as an audio recording, the content recording platform 105 may deliver the audio recording as a voice mail (e.g., the user calls a central number to retrieve the recording), E-mail attachment, MMS message, or an Internet link to the file. Similarly, the content recording platform 105 may deliver a video recording as an E-mail attachment, MMS message, or an Internet link to the file. For speech-to-text transcripts, the platform 105 may deliver the transcript as an E-mail attachment, sequence of SMS messages, Instant Message, or an Internet link to the file.

The content recording platform 105 also enables the user to freely choose what device or devices will receive the recorded communication session. Based on the user's preferences and rules, the platform 105 can deliver the recording to the user's device (e.g., mobile device 103, laptop 117, telephony device 125) and/or to third party devices in any combination or number. For example, the user may set up a distribution list of devices that will automatically receive a recorded communication. The user can even configure the content recording platform 105 to record a communication session and deliver it to local authorities through the 911 emergency phone line.

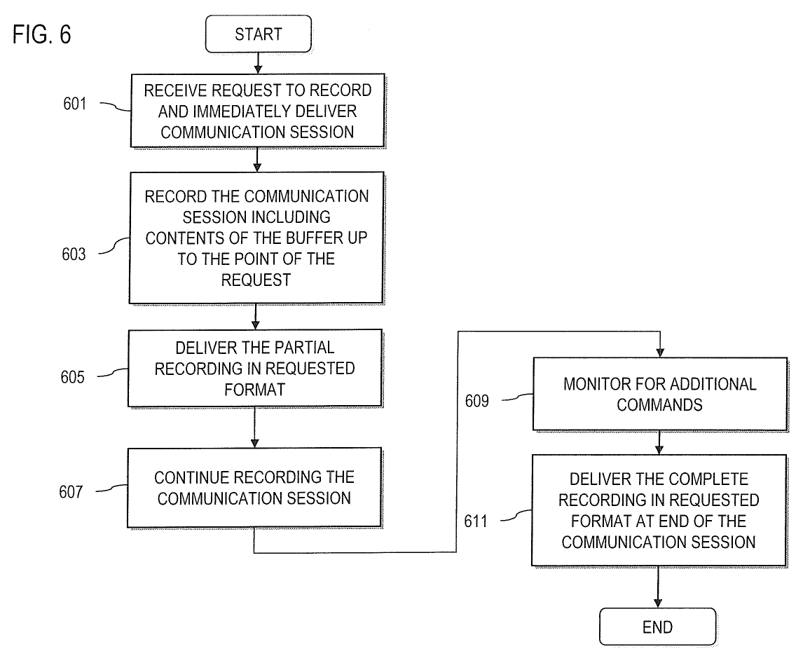

FIG. 6 is a flowchart of a process for recording and delivering a partial communication session, according to an exemplary embodiment. Under this recording option, the content recording platform 105 receives a request from the user to record an ongoing communication session and to immediately deliver a partial recording of the session (step 601). This option can be helpful in situations where information, even though potentially incomplete, must be conveyed immediately to the intended recipients. This type of situation may arise in circumstances such as the school bomb threat example discussed above.

In response to this request, the content recording platform 105 will begin recording the session including the portion of the communication of the session that has already been captured by the platform's buffer (step 603), just as in a normal recording request. However, the content recording platform 105 also will immediately deliver a recording of the session up to the point of the recording request to the specified device or devices in the specified format (605). In this way, the user can request and receive delivery of a recording of a communication session even before the session has ended.

After delivering the partial recording, the content recording platform 105 continues to record the rest of the communication session and monitors for additional user requests (steps 607-609). The user, for example, can initiate one or more additional requests for a partial recording during the communication session. Each time the request is received, the content recording platform 105 delivers a recording of the entire session up to the point of the recording request. Each subsequent recording request results in a recording that includes additional portions of the session recorded since the prior request. At the end of the communication session in step 611, the content recording platform 105 will deliver a final complete recording of the communication session to the specified device or devices in the specified format.

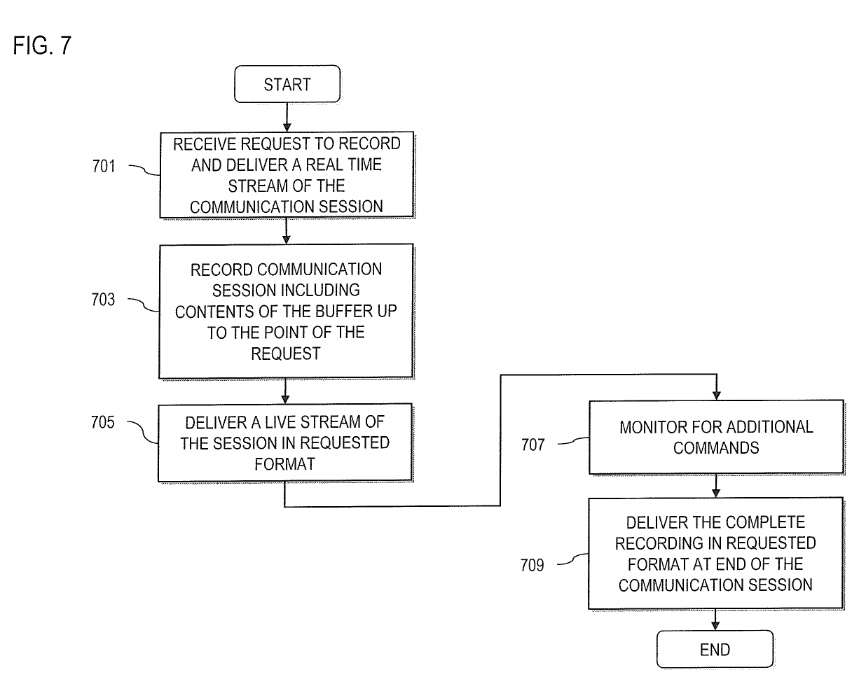

FIG. 7 is a flowchart of a process for recording and delivering a communication session in real-time, according to an exemplary embodiment. Under this recording option, the content recording platform 105 receives a request from the user to record an ongoing communication session and to immediately deliver a live stream of the communication session to another device or devices (step 701). This option can be helpful in situations where a user wants to share a live feed of an ongoing communication session, but is unable to directly conference in one or more third parties.

After receiving the request, the content recording platform 105 starts recording the communication session including the portion of the session that has already been captured by the platform's buffer (step 703). At the same time, the content recording platform 105 immediately begin providing a live stream of the communication session to the specified device or devices in the specified format (step 705). In this embodiment, the content recording platform 105 can provide a live audio or video stream via an Internet link or provide a continuous speech-to-text transcription via SMS, video captioning, Instant Messaging, or E-mail. During the communication session, the content recording platform 105 continues to monitor for and execute additional user requests (step 707). At the end of the communication session in step 709, the content recording platform 105 delivers a final complete recording of the communication session to the specified device or devices in the specified format.

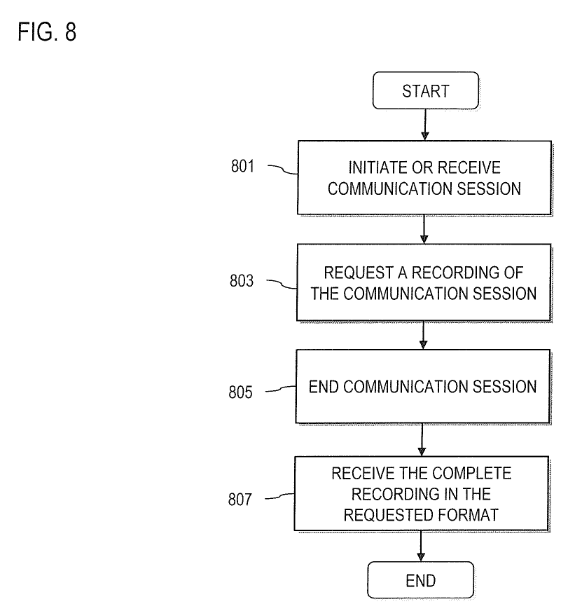

FIG. 8 is a flowchart of a process for using a content buffering, recording, and delivery service, according to an exemplary embodiment. This process assumes that the user has completed the service provisioning and setup process described with respect to FIG. 3. Once subscribed to the content buffering, recording, and delivery service, the user accesses the service by initiating or receiving a communication session on the communication system 100 (step 801). The communication session can be any real-time communication format such as voice, video, or multimedia conferencing. As previously discussed, the content recording platform 105 automatically buffers the user's communication session according to the user's preferences and rules.

During the communication session, the user can request a recording of the ongoing session by entering a preconfigured key sequence (step 803). During setup, the user creates any number of recording rules and designates unique key sequences to invoke them. For example, the user can initiate a recording and delivery of the communication session after the session ends by entering the key sequence “*R.” If the user wants to deliver a live stream of the session, the user can enter the key sequence “*L.” Additionally, the user can designate certain key sequences to initiate recordings that are “secret” (i.e., undetected by other communication parties.). For instance, in the bomb threat example discussed above, the administrator most likely would not want to alert the person making the bomb threat the she is recording the communication session. In this case, the administrator can use the “secret” key sequence to initiate recording without alerting the other party. The content recording platform 105 will respond to the user's request and provide the requested recording. After the user ends the communication session in step 805, the user will receive a complete recording of the communication in the user's requested format and sent to the user's designated device or devices per step 807.

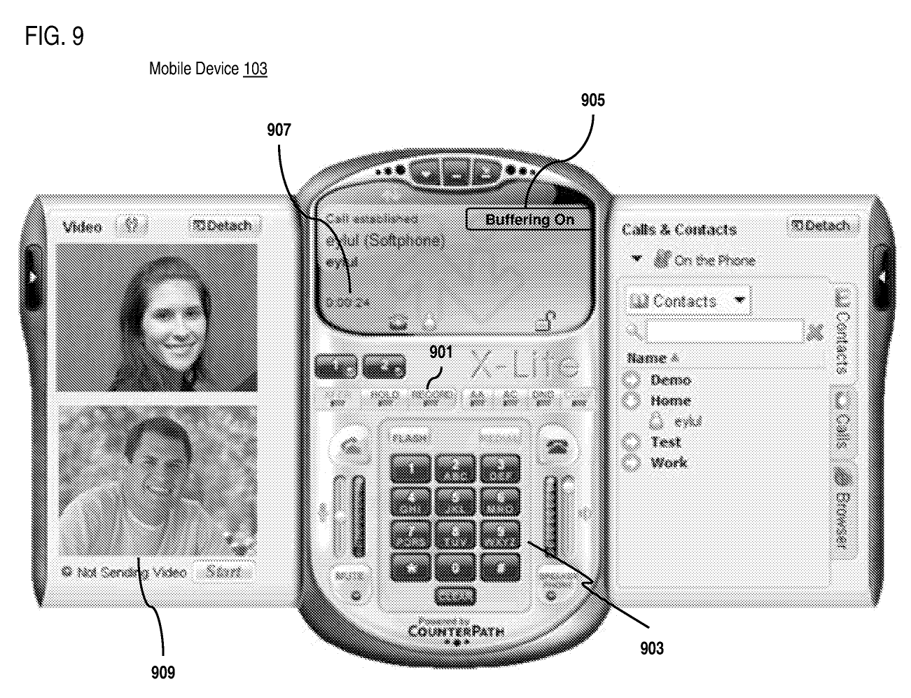

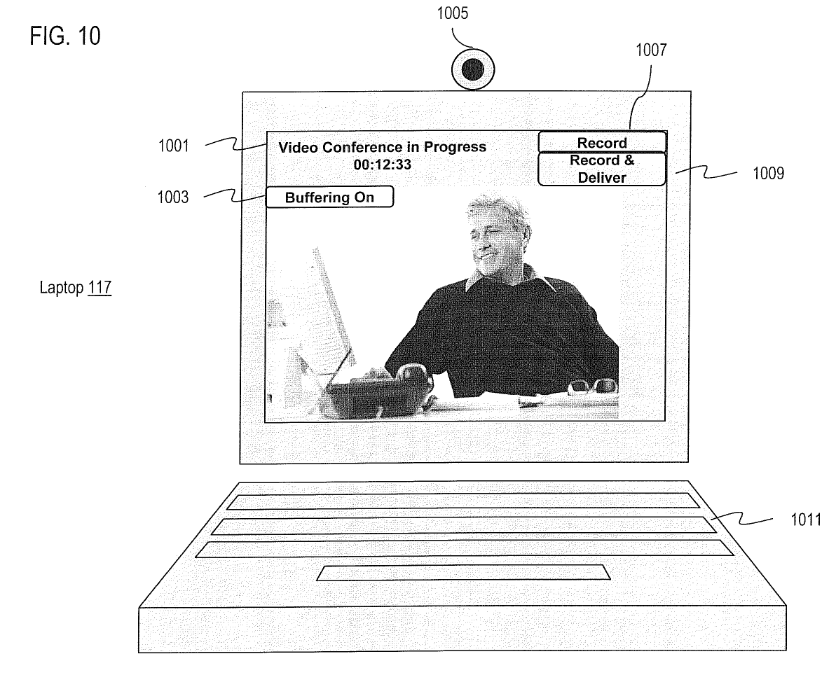

FIGS. 9 and 10 depict and describe exemplary devices for accessing and controlling the content recording platform 105. Although these figures describe a mobile device 103 and laptop 117 for use with the platform 105, it is contemplated any device capable of communications over a telephony network 121 or data network 112 may be used.

FIG. 9 is a diagram of the controls and user interface of a mobile device utilized in the processes of FIGS. 2-8, according to an exemplary embodiment. Mobile device 103 includes a “hard” button 901 (i.e., actual, physical button) to initiate recording of communication sessions. It is contemplated that various embodiments of mobile device 103 can be equipped with additional hard buttons, “soft” buttons, or on-screen menu controls to control the content recording platform 105. Users also may use the keypad 903 to enter key sequences to invoke preconfigured recording options and rules (e.g., “*R” to initiate recording, “*D” to request immediate delivery of a partial recording). The main display screen of the device 103 can include status indicators relevant to the functioning of the content recording platform 105. For example, indicator 905 shows whether the content recording platform 105 is buffering the current communication session. As depicted in FIG. 9, this embodiment uses the label “Buffering On” to indicate that the platform I 105 is actively buffering the session. It is contemplated that buffering status may be indicated using status lights, icons, or other suitable indicator. The mobile device 103's main display also can include a call progress indicator 907 to help determine how much buffering capacity has been used during the current communication session.

In certain embodiments, the mobile device 103 can be equipped with a variety of sensory input and output mechanisms such as audio (e.g., through a microphone and speaker), video (e.g., through a camera and video display), and touch (e.g., through touch input and haptic feedback) to provide a richer multimedia experience. In this example, mobile device 103 includes video display 909 to facilitate video calls and multimedia conferencing.

FIG. 10 is a diagram of the controls and user interface of a laptop device utilized in the processes of FIGS. 2-8, according to an exemplary embodiment. Laptop 117 is an exemplary computing device capable of multimedia communications that can be used with the content recording platform 105. The laptop 117 includes a video camera 1005 to facilitate video calling/conferencing and a keyboard 1011 to enter key sequences to control the content recording platform 105. Like mobile device 103, the laptop's on-screen user interface can include a buffering indicator 1003 and communication session progress indicator 1001 to provide feedback on the platform's buffering status and capacity. In addition to entering key sequences on keyboard 1011, the laptop 117 can display soft control buttons (e.g., soft button 1007 for initiating recording, and soft button 1009 for requesting immediate delivery of a partial recording) to control the various functions of the content recording platform 105.

It is contemplated that the multimedia capabilities of the laptop 117 can be expanded with the addition of the various sensory input and output mechanisms discussed above with respect to mobile device 103.

The processes described herein for providing content buffering, recording, and delivery may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

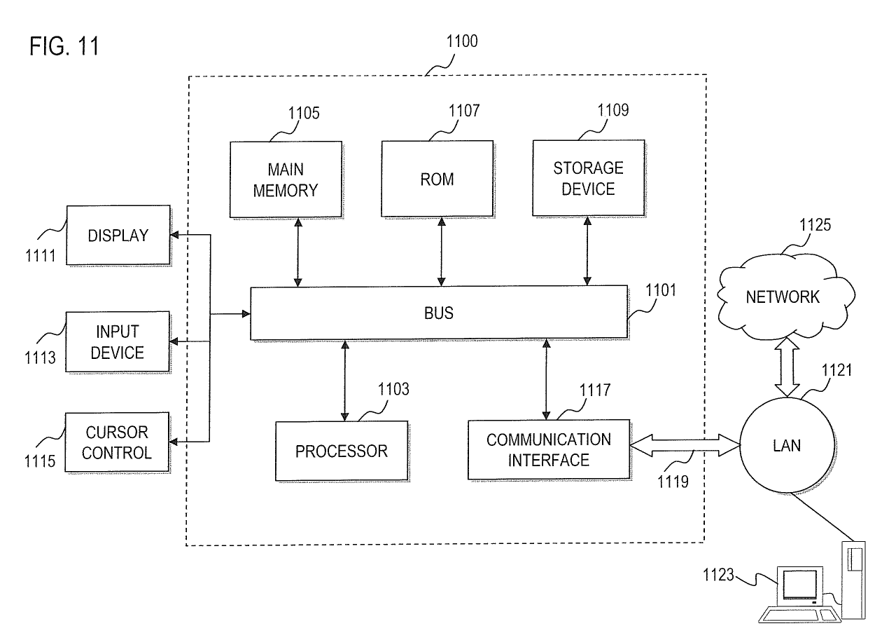

FIG. 11 illustrates computing hardware (e.g., computer system) upon which an embodiment according to the invention can be implemented. The computer system 1100 includes a bus 1101 or other communication mechanism for communicating information and a processor 1103 coupled to the bus 1101 for processing information. The computer system 1100 also includes main memory 1105, such as random access memory (RAM) or other dynamic storage device, coupled to the bus 1101 for storing information and instructions to be executed by the processor 103. Main memory 1105 also can be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modern, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a request, from a user device, to record media content transported in a communication session with the user device;
retrieving a rule for treatment of the content; and
buffering and delivering the media content, according to the rule, during the communication session.

2. A method of claim 1, wherein the rule specifies one of key sequences to initiate recording and delivery of media content, buffering time, duration of the recording, a target device for receiving delivery of the media content, media type for the delivery, or any combination thereof.

3. A method of claim 2, wherein the target device includes either a wireless device, a web server, a mobile computer, set top box, or a desktop computer.

4. A method of claim 2, wherein the communication session includes voice communication, text-based communication, video communication, or multimedia communication.

5. A method of claim 2, wherein the media type includes electronic mail, instant communication, short message service, multimedia messaging service.

6. A method of claim 1, wherein the communication session is established with another device of another user, and the recording is undetected by the other user.

7. A method of claim 1, wherein the request is initiated by the user device by either an assigned key, a predetermined key sequence, a physical button, a soft button, or a combination thereof.

8. A method of claim 1, wherein the user device initiates an emergency call in response to generation of the request.

9. A method of claim 1, wherein the delivery of the media content is in real-time.

10. An apparatus comprising:
a communication interface to receive a request, from a user device, to record media content transported in a communication session with the user device; and
a processor configured to retrieve a rule for treatment of the content, wherein the processor is further configured to buffer and deliver the media content, according to the rule, during the communication session.

11. An apparatus of claim 10, wherein the rule specifies one of key sequences to initiate recording and delivery of media content, buffering time, duration of the recording, a target device for receiving delivery of the media content, media type for the delivery, or any combination thereof.

12. An apparatus of claim 11, wherein the target device includes either a wireless device, a web server, a mobile computer, set top box, or a desktop computer.

13. An apparatus of claim 11, wherein the communication session includes voice communication, text-based communication, video communication, or multimedia communication.

14. An apparatus of claim 11, wherein the media type includes electronic mail, instant communication, short message service, multimedia messaging service.

15. An apparatus of claim 10, wherein the communication session is established with another device of another user, and the recording is undetected by the other user.

16. An apparatus of claim 10, wherein the request is initiated by the user device by either an assigned key, a predetermined key sequence, a physical button, a soft button, or a combination thereof.

17. An apparatus of claim 10, wherein the user device initiates an emergency call in response to generation of the request.

18. An apparatus of claim 10, wherein the delivery of the media content is in real-time.

19. A system comprising:
a platform configured to receive a request from a user device over a communication network to record media content transported in a communication session with the user device; and
a database configured to store a rule for treatment of the content, wherein the platform is further configured to buffer and deliver the media content, according to the rule, during the communication session.

20. A system of claim 19, wherein the system is controlled by a service provider.
